(19) United States
(12) Patent Application Publication
(10) Pub. No.: US 2024/0253463 A1
(43) Pub. Date: Aug. 1, 2024

(54) METHOD FOR MANUFACTURING A CONTROL DEVICE, AND CONTROL DEVICE

(71) Applicants: NOVARES FRANCE, Vélizy-Villacoublay (FR); NANOMADE LAB, TOULOUSE (FR)

(72) Inventors: Christophe CAZES, VERSAILLES (FR); François LELIEVRE, ANTHONY (FR); Fabrice SEVERAC, TOULOUSE (FR); Nicolas DUFOUR, VALLEGUE (FR)

(21) Appl. No.: 18/289,655

(22) PCT Filed: Apr. 25, 2022
(86) PCT No.: PCT/FR2022/050775

§ 371 Date: Nov. 6, 2023

(30) Foreign Application Priority Data
May 6, 2021 (FR) 21/04808

(51) Int. Cl. B60K 35/10; B21J 9/20; G01D 5/24

(52) U.S. Cl. CPC B60K 35/10; B21J 9/20; G01D 5/24; B60K 2360/96

(57) ABSTRACT

A method for manufacturing a detection assembly for a control device intended to be integrated into a motor vehicle passenger compartment, the detection assembly including a panel comprising a raised sector provided with an edge, and a sheet including a detection surface provided with at least one sensor, the method including a step of forming at least one flap in the detection surface, a positioning step in which the sheet is positioned facing the panel, the detection surface being positioned opposite the raised sector, and a securing step in which the sheet is applied against the panel, the flap being moved so as to come into contact with an edge of the raised sector.

### CROSS REFERENCE TO RELATED APPLICATIONS

This application is a National Stage of PCT Application No. PCT/FR2022/050775 filed on Apr. 25, 2022, which claims priority to French Patent Application No. 21/04808 filed on May 6, 2021, the contents each of which are incorporated herein by reference thereto.

### TECHNICAL FIELD

The present disclosure concerns a method for manufacturing a control device for a motor vehicle intended to control several functions of said vehicle.

### BACKGROUND

The passenger compartment of a motor vehicle constitutes for users—driver and possible passengers—a place of life and interaction with controls which make it possible to monitor functions of the vehicle; these functions are very diverse in nature and can concern in particular the opening and the closing of the vehicle doors, the orientation of the lateral mirrors, as well as the opening and the closing of the windows fitted to the lateral doors of the vehicle. The controls typically found inside a vehicle and which constitute the interface for monitoring the functions of a vehicle are in particular of the type:
push buttons to, for example, control the locking of a vehicle,
rotary buttons to, for example, control the temperature setting of the air conditioning system;
rocker buttons to, for example, control the opening/closing mechanism of the windows
trigger to, for example, control the door opening mechanism
sliders to, for example, control the temperature setting of the air conditioning system

Such control devices are located in several places within the passenger compartment, for example on the door trims, within the armrest, near the gear lever, or even on the steering wheel.

The passenger compartment of the vehicle is thus equipped with a multitude of control members. These control members—buttons, sliders, etc.—are of mechanical or electromechanical type. As such, these control members are, on the one hand, relatively expensive and on the other hand, present significant installation constraints in the passenger compartment of the vehicle since they can only be positioned in locations which allow their mechanisms to be accommodated. This last constraint therefore greatly reduces the freedom of design of the passenger compartment since the location of these members is dictated not according to ergonomic considerations but according to mechanical constraints which may be in contradiction with the ergonomic considerations.

In order to overcome such constraints, it is known to use a control device with electrical controls. The device then comprises a panel provided with inoperative zones and control zones.

Each of the control zones is assigned to a specific function of the motor vehicle. The control device comprises a sheet sensitive to touch via a detection surface coated with sensors. The sheet is arranged under the panel in such a way that each of the sensors are contiguous, that is to say, facing one of the control zones.

Each sensor is configured to detect the presence of a user's finger, by sending a signal to an electronic control unit arranged on a printed circuit board.

The contiguity between the sensors and the control zones is essential to enable good detection of the user's finger, and thus guarantee good responsiveness of the selected function.

The control zones are arranged on a flat sector or a raised sector. By raised sector, reference is made to any zone having an awkward shape, for example an embossment or a cavity.

The sheet is thermoformed on an inner surface of the panel, in order to allow it to match the shapes of the panel. Such a method for assembling the sheet on the panel consists of heating the sheet to a predetermined temperature, before applying it by pressure on an inner surface of the panel.

An example of such a control device is described in WO 201358708 (FISCHER TECHNOLOGY).

A thermoforming method allows the sheet to be adjusted to the shape of the panel. However, it was observed following the application of the sheet on the panel, a lack of contiguity, in other words an offset between the control zones presenting raised sectors, and the sensors. Such an anomaly comes from excessive stretching of the sheet during its application to the inner surface. The stretching causes a deformation which remains when the sheet hardens after cooling.

The lack of contiguity results in the sensors themselves being deformed, or else being displaced and not facing the control zones. The contact detection is then deficient, because the measured physical value no longer corresponds to the physical value as initially envisaged. It is therefore necessary before commissioning the control device to recalibrate the sensor. Yet, such recalibration impacts the manufacturing time of the panel, as well as the overall production cost of the control device.

Moreover, such a thermoforming operation can damage the sensors themselves because the hot deformation of the sheet presenting these sensors can be significant in certain places, in particular when the panel comprises raised sectors with complex shapes or with pronounced radii of curvature.

Also, the method for manufacturing the control device is energetically expensive, in particular due to the use of a heat source to enable the thermoforming to be carried out.

### BRIEF SUMMARY

The present disclosure aims in particular to resolve the aforementioned drawbacks.

A first objective is to propose a method for manufacturing a panel which is eliminates the need for recalibration of the sensor, while offering the most possible optimal detection precision.

A second objective is to propose such a method which makes it possible to produce a control device having raised sectors of very complex shape.

A third objective is to propose such a method, which offers limited energy consumption.

A fourth objective is to propose such a method, which requires a minimum number of steps.

A fifth objective is to propose a panel obtained by the method presented above.

A sixth objective is to provide a motor vehicle including such a panel.

To this end, it is proposed firstly a method for manufacturing a detection assembly for a control device intended to be integrated into a passenger compartment of a motor vehicle, the detection assembly including a panel including at least one raised sector provided with an edge, a sheet including a detection surface provided with at least one sensor, the method including a step of forming at least one flap in the detection surface, a positioning step, the sheet being positioned facing the panel, the detection surface being positioned facing the raised sector, a securing step, the sheet being applied against the panel, the flap being displaced during the securing step to come into contact with an edge of the raised sector.

The production of flaps which are applied to raised sectors makes it possible to avoid a deformation of the sensors when applying the sheet, and to avoid the thermoforming when securing the sheet to the panel.

Advantageously, the forming step comprises making cuts or pre-cuts within the detection surface, according to a predetermined pattern, so as to define a flap.

Advantageously, the cuts or pre-cuts are made using a cookie cutter tool or a laser.

In one embodiment, the method comprises between the forming step and the positioning step, or before the forming step, a gluing step including the application of glue to the sheet.

Advantageously, the sheet is provided with an inactive surface devoid of sensor, the gluing step comprises the application of a first glue on the inactive surface, and a second glue on the detection surface, after hardening of the first glue and the second glue, the second glue offering rigidity greater than that of the first glue.

In one embodiment, the securing step is carried out by a die-forging machine, the die-forging machine including a die capable of translating, the die-forging machine including a movable part and a fixed part, the movable part being capable of translating relative to the fixed part so as to move between a retracted position and a contact position, the sheet being arranged on the die such that the movable part is facing the detection surface, the die-forging machine carrying out a first movement aimed at placing the sheet against the panel via the fixed part, and during a second movement, the movable part is moved from a retracted position to a contact position so as to apply the detection surface against the raised sector.

Secondly, a detection assembly is proposed including: a panel including at least one raised sector provided with an edge, as well as a sheet including a detection surface provided with at least one sensor, the sheet being secured facing the panel, the detection surface being positioned facing the raised sector, the detection assembly including a flap secured to an edge of the raised sector.

Thirdly, a control device is proposed including a detection assembly as presented above.

Fourthly, a motor vehicle is proposed equipped with the control device as presented above.

### BRIEF DESCRIPTION OF THE DRAWINGS

Other characteristics and advantages of the present disclosure will appear more clearly and concretely on reading the following description of embodiments, which is made with reference to the appended drawings in which:

FIG. 1 represents a schematic exploded perspective view of a control device according to a first embodiment;

FIG. 2 represents a schematic cross-sectional view of a control device according to a first embodiment;

FIG. 3 represents a schematic front view of a dashboard provided with a control device according to a second embodiment;

FIG. 4 represents a schematic perspective view of an embodiment of a detection assembly of FIG. 3;

FIG. 5 represents a schematic top view of a sheet of the detection assembly of FIG. 4;

FIG. 6 represents a schematic perspective view of the detection assembly of FIGS. 3 and 4,

FIG. 7 represents a flowchart of a method for manufacturing a detection assembly of a control device according to the first embodiment;

FIG. 8 represents a schematic perspective view of a sheet during a forming step;

FIG. 9 represents a schematic sectional view of a panel during a securing step;

FIG. 10 represents a schematic sectional view of a panel during a securing step;

FIG. 11 represents a schematic sectional view of a panel during a securing step;

FIG. 12 represents a schematic perspective view of a control device during a final assembly step.

### DETAILED DESCRIPTION

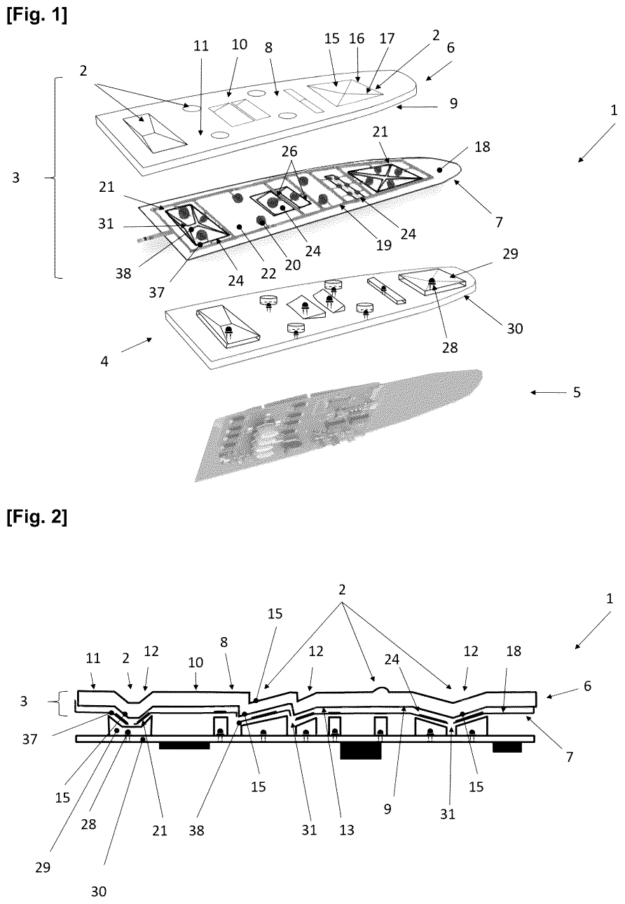

FIGS. 1 to 3 and 12 represent a control device 1.

Such a control device 1 is intended to be integrated within a vehicle, for example a motor vehicle (not shown).

In a first embodiment shown in particular in FIGS. 1, 2 and 12, the control device 1 is intended to be implemented within a door of a motor vehicle (not shown). The functions performed by the control device 1 of such an embodiment are for example the opening and the closing of the lateral windows, the locking and unlocking of the doors, as well as the orientation of the lateral mirrors.

In a second embodiment shown in FIG. 3, the control device 1 is intended to be integrated into the dashboard 1000 of a vehicle or even forms a central console module of a vehicle and comprises for example controls for the functions of starting the vehicle engine, or ventilation of the passenger compartment.

In other non-shown embodiments, the control device 1 is integrated into other interior parts of the vehicle, for example a gear lever, a directional steering wheel, a control box near a steering wheel such as a combination control, or an armrest of a seat or a door panel.

Generally, the control device 1 makes it possible to create an interface between the user and a monitoring unit, for example a vehicle on-board computer. More precisely, the control device 1 comprises one or a plurality of control zones 2 allowing the actuation or performance of a function.

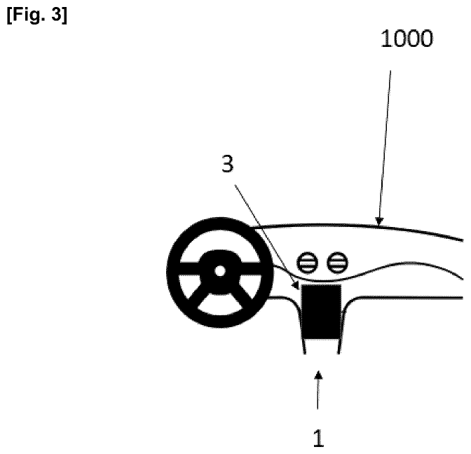

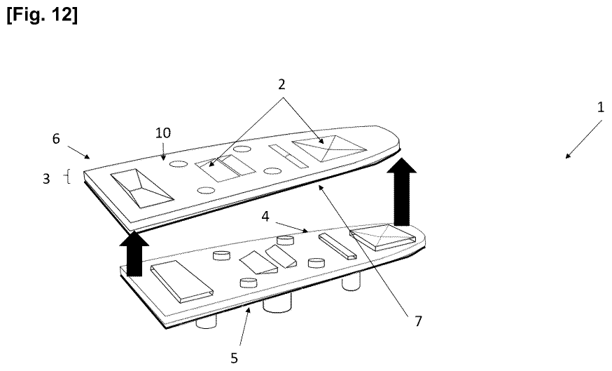

The control device 1 comprises a detection assembly 3, advantageously assembled on an intermediate element 4, and a printed circuit board 5 as illustrated for example in FIG. 2 and FIG. 12.

The detection assembly 3 comprises a panel 6, and a sheet 7 advantageously assembled on the panel 6.

In the shown embodiments, the panel 6 offers a general structure of a shell. Such an arrangement allows the panel 6 to be easily inserted into the trim of a door in the case of the first embodiment, or on a dashboard or on a central console module for the second embodiment.

The panel 6 is preferably made of a thermoplastic material, and is obtained by a molding method, for example by injection molding.

The panel 6 comprises for example an outer surface 8, intended to be visible in the vehicle and to receive the user's finger. The panel 6 also comprises an inner surface 9, normally not accessible to the end user, when the control device 1 is integrated into the vehicle. The inner surface 9 receives the elements making it possible to control the function selected by the user.

The panel 6 comprises at least one control zone 2, intended to receive the user's finger, and an inoperative zone 10, which in the exemplary embodiment is flat.

Each control zone 2 is assigned to one or more specific functions, said function(s) being carried out as soon as the user activates the control zone 2, for example by exerting pressure on the latter with his finger.

The outer surface 8 is for example provided with paint, or pictograms, informing the user of the functions that he can operate or control using the control zone 2.

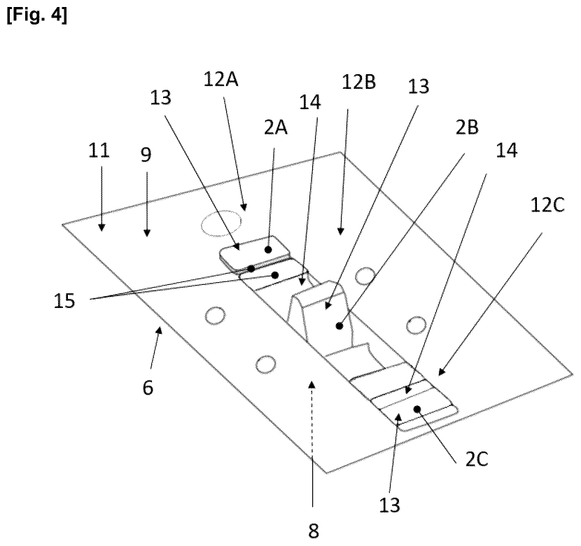

As can be seen in particular in FIG. 2 or in FIG. 4, the panel 6 comprises flat sectors 11 and raised sectors 12, 12A, 12B, 12C. The raised sectors 12, 12A, 12B, 12C comprise embossments 13 projecting from the inner surface 9, or cavities 14 recessed relative to the inner surface 9.

Such raised sectors 12 are advantageously provided with a plurality of edges 15 defining for example a polygonal geometric figure. Such edges 15 are intended to be subjected to a force by the user's finger. As illustrated in FIG. 1, the edges 15 are for example connected to the flat sector 11 via a first edge 16, and are connected to each other via at least one second edge 17.

It will be described now more particularly the sheet 7, with reference to FIGS. 1, 5, 6 and 8.

The sheet 7 is advantageously made of a thermoplastic material, for example a polymer substrate, such as that used for flexible printed circuits, or polyethylene terephthalate (PET) coated with indium-tin oxide (ITO). In order to facilitate its assembly on the inner surface 9 of the panel 6, the sheet 7 is produced with such flexibility that it can for example be rolled up manually.

The sheet 7 comprises for example an active face 18 advantageously coated with a substrate (not apparent in the figures) allowing the printing of tracks 19 and sensors 20. The tracks 19 are connected to sensors 20, as well as to printed circuit board 5. The tracks 19 can undergo deformations without this having any impact on the general operation of the control device 1, whereas a deformation of the sensors 20 is detrimental to its operation.

Advantageously, the sensor 20 is a capacitive sensor, but in non-described embodiments another type of sensor is used, for example a resistive sensor.

In the shown embodiments, the sheet 7 comprises a plurality of detection surfaces 21, each assembled on a control zone 2. The sheet 7 comprises an inactive surface 22, assembled on an inoperative zone 10. The detection surfaces 21 accommodate one or more sensors 20, while the tracks 19 preferably extend over the inactive surface 22.

In the first embodiment, the inactive surface 22 takes the form of a flat surface.

In the second embodiment, the inactive surface 22 is in the form of an assembly of several flat surfaces separated by folds 23.

A detection surface 21 comprises for example a flap 24 or several flaps 24 including one or more sensors 20. Such flaps 24 are obtained by cutting, as described later in the description. Advantageously, the flap 24 comprises at least one facet 25 intended to be secured by gluing to an edge 15. A flap 24 is connected to the inactive surface 22 via a hinge 26.

In the first embodiment, each of the flaps 24 has a single facet 25.

In the second embodiment, the flaps have several facets 25. In such an embodiment, the facets 25 are connected to each other via a fold 27. Thanks to the plurality of facets 25, it is possible to reconstitute using a flap 24 a large number of raised sectors 12, by arranging the facets 25 and the folds 27 in a suitable manner.

The facets 25 advantageously have a shape identical to the edge 15 on which they are glued, and are therefore polygonal. The facets 25 are for example triangular, rectangular or trapezoidal.

In the first embodiment, each flap 24 is provided with a single sensor 20. Thus, each flap 24 is associated with a single function of the raised sector 12.

In other advantageous implementations, such as for example those of the second embodiment, the flap 24 comprises several sensors 7, which allows a single edge 15 of the raised sector 12 to offer several different functions.

In the first embodiment, the flap 24 defines a facet 25 comprising first free sides 37, and a second side 38 connecting the flap 24 with the sheet 7. The second side 38 forms a hinge 26 matching the first edge 16, and an angle between the edge 15 and an inoperative zone 10. In this way, the control zone 2 is contiguous to the sensor 20, allowing to obtain an optimal detection precision.

It will be described in more detail the panel 6 of the detection assembly 3 according to the second embodiment, with particular reference to FIG. 4, which represents the panel 6 with the visible inner surface 9. Such a panel 6 comprises several raised sectors 12A, 12B, 12C. A first raised sector 12A defines an embossment 13 of substantially parallelepiped shape. A second raised sector 12B defines a shape having a part with a cavity 12 and a part with an embossment 13. A third raised sector 12C defines a wavy shape.

The raised sectors 12A, 12B, 12C are respectively intended to receive first control zones 2A, second control zones 2B and third control zones 2C.

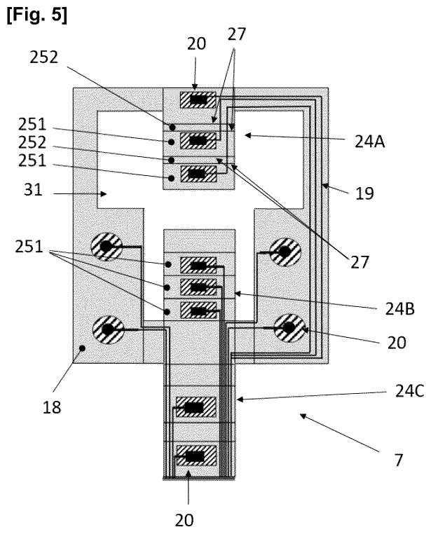

As can be seen in FIGS. 5 and 6, the sheet 7 comprises a first flap 24A, a second flap 24B and a third flap 24C. Such flaps 24A, 24B and 24C are respectively linked to the first raised sector 12A, to the second raised sector 12B, and to the third raised sector 12C. The flaps 24A, 24B, 24C have an advantageously rectangular outline, which makes them easier to obtain.

Advantageously, in the second embodiment, the flaps 24A, 24B, 24C comprise first facets 251, provided with sensors 20 as well as second facets 252 devoid of sensors 20.

Advantageously, the first flap 24A comprises two second facets 252 each arranged between two first facets 251. In this way, the first flap 24A matches as closely as possible to the first raised sector 12A, thanks to the folds 27 between the facets 251, 252. Any recalibration of the sensors 20 after assembly of the sheet 7 on the panel 6 is thus avoided.

Advantageously, the second flap 24B comprises three first facets 251, and a second facet 252 disposed at the end of the second flap 24B. In this way, the second flap 24B matches as closely as possible to the second raised sector 12B, thanks to the folds 27 between the facets 251, 252. Any recalibration of the sensors 20 after assembly of the sheet 7 on the panel 6 is thus avoided.

Advantageously, the third flap 24C comprises two first facets 251, arranged alternating with second facets 252. In this way, the third flap 24C matches as closely as possible the shape of the third raised sector 12C and in particular the cavities 14, thanks to the folds 27 between the facets 251, 252. Any recalibration of the sensors 20 after assembly of the sheet 7 on the panel 6 is thus avoided.

As can be seen in FIG. 6, in such a second embodiment, complex and different shapes of the raised sectors 12A, 12B, 12C can be covered by the sheet 7 thanks to the arrangement of folds 27 and facets 251, 252. In this way, the sensors 20 are facing the control zones 2A, 2B, 2C

It will be described now the intermediate element 4 by referring again to FIGS. 1, 2 and 8 to 12. Such an intermediate element 4 comprises for example a plurality of light-emitting diodes 28 and a plurality of light guides 29. As illustrated in FIG. 2, the light guides 29 advantageously have a raised profile substantially complementary to that of the control zones 2 so as to facilitate the mounting of the control device 1.

The printed circuit board 5 is notably made up of a support 30 on which electronic components are fixed. The support 30 is for example formed of a thermoplastic material, giving it sufficient rigidity to be installed within the vehicle and allowing it to be used.

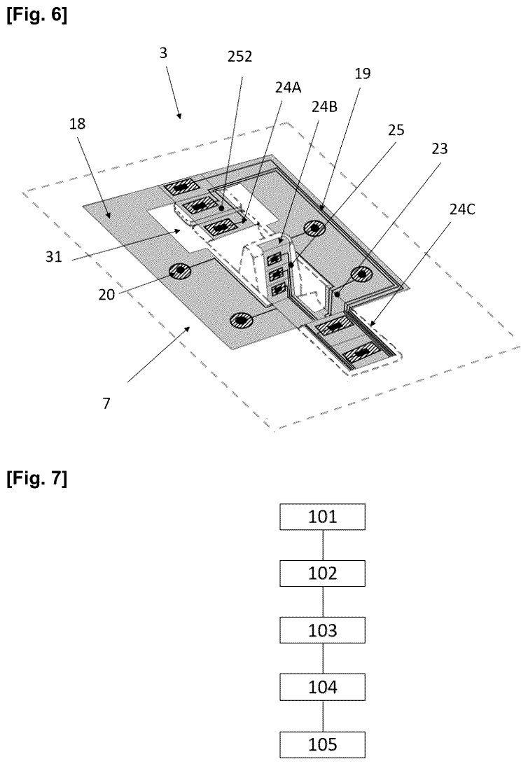

It will be described now an example of a method for manufacturing 100 the control device 1 with reference to FIGS. 7 to 12. The method 100 is described below with reference to the control device 1 according to the first embodiment, but is applicable in the same way to the control device 1 of the second embodiment

In a gluing step 101, the detection surface 21 and the inactive surface 22 of the sheet 7 are coated with a glue or an adhesive, so as to allow the assembly of the sheet 7 on the inner surface 9 of the panel 6. The use of glue makes it possible to assemble the sheet 7 by gluing, making it possible to dispense with the thermoforming of said sheet 7 which consumes energy. In addition, the fact of coating the sheet 7 with glue limits the risk of deformation of the sheet 7, unlike a thermoforming operation which weakens the sensors 20 during the deformation of the sheet 7.

Advantageously, the inoperative zone 10 is coated with a first glue, and the control zone 2 is coated with a second glue. In such an implementation, the first glue and the second glue are selected such that after hardening, the second glue offers greater rigidity than that of the first glue. In this way, after assembly of the sheet 7 on the inner surface 9, the detection surfaces 21 and the inoperative zones 3 have a different rigidity.

Such an arrangement prevents a deformation of a control zone 2 following the application of a force by the user from being transmitted to an inactive surface 22, or to another detection surface 21. In this way, an effort caused by the pressure of a finger of the user on an edge 15 will only activate the detection of the sensor 20 associated with the edge 15, and not another sensor 20. The detection precision is thus ensured. The occurrence of an unwanted deformation of any sensor 20 not linked to the function selected by the user is therefore considerably limited, avoiding any recalibration after assembly of the panel 2.

The fact of coating the detection surfaces 21 with a more rigid glue than that used for the inactive surfaces 22 also makes it possible to concentrate the risk of deformation at the level of the tracks 19, and not the sensors 20. The risk of deformation of the sensors 20 is reduced, which helps to avoid any subsequent recalibration of the sensors 7.

Advantageously, after the gluing is carried out, a protective film is placed on the surfaces 21, 22 of the sheet 5, which makes it possible to protect the glue from any dirt or impurity. In this way, the sheet 7 can be handled, displaced and stored without difficulty.

In a forming step 102, cutouts 31 are made within the detection surface 21, according to a predetermined pattern, so as to form the flap 24. The pattern is determined as a function of the raised sector 12 and the edges shape 15.

In the shown embodiment, the cutouts 31 are made with a cookie cutter tool or a laser, which allows rapid and economical formation of the flaps 24.

If necessary, the protective film is removed from the glued surfaces, before any securing between the panel 6 and the sheet 7.

In an alternative embodiment, the gluing step 101 is carried out after the forming step 102, which eliminates the need for a protective film.

In a positioning step 103, the sheet 7 is placed facing the panel 6, for example facing the inner surface 9. In such a situation, the detection surface 21 is positioned facing the raised sector 12.

In a securing step 104, the sheet 7 is brought closer to the panel 6 until the sheet 7 is secured to the inner surface 9, for example by being kept applied for the time that the gluing between the previously glued surfaces 21, 22, and the inner surface 9 takes place. In such a securing step 104, a flap 24 is displaced to come into contact with an edge 15 of the raised sector 11 facing it.

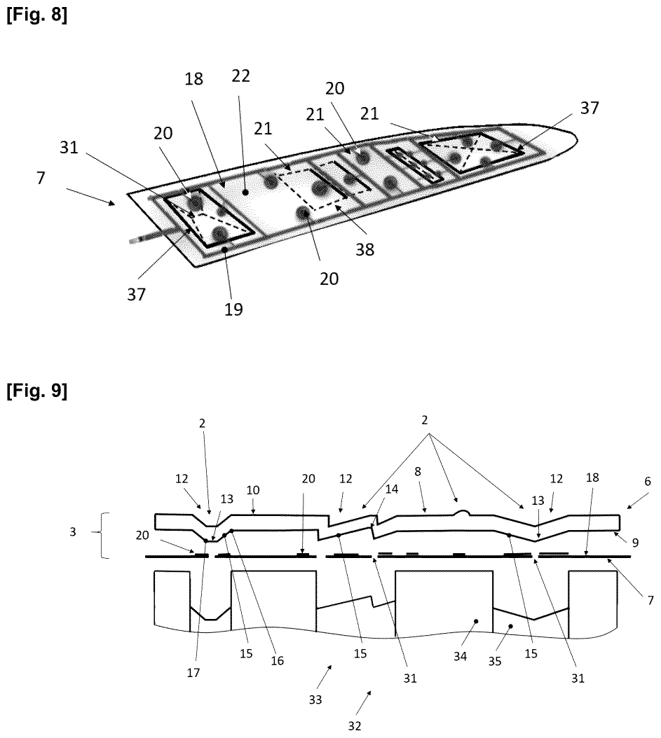

The positioning step 103 and the securing step 104 are advantageously carried out on a die-forging machine 32 as shown in FIGS. 9 to 11.

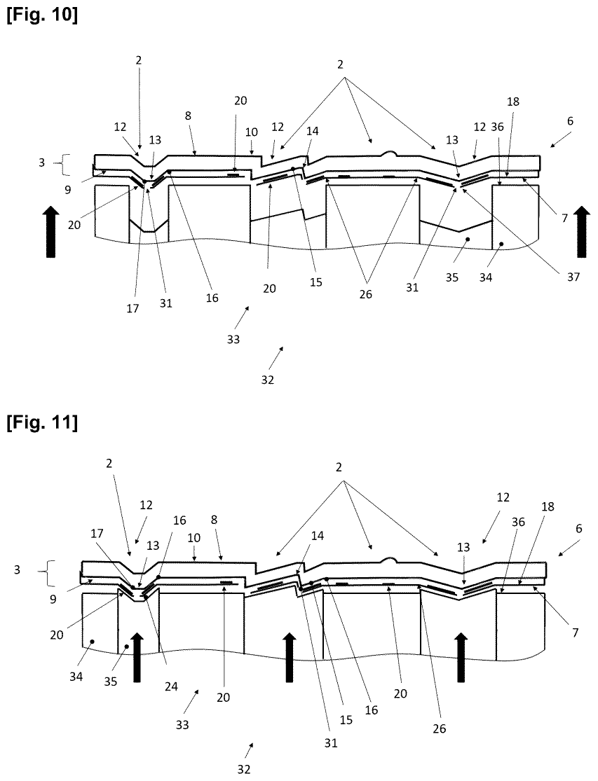

Such a die-forging machine 32 comprises a die 33, which translates for example in a vertical direction. The die 33 is advantageously provided with fixed parts 34, and movable parts 35. The die 33 is displaced in translation, between a distal position shown in FIG. 9, and a proximal position shown in FIGS. 10 and 11. The movable parts 35 can be displaced in translation within the die 33, moving between a retracted position visible in the FIGS. 9, 10, and a contact position visible in FIG. 11.

The die 33 advantageously has a contact surface 36 which defines a shape complementary to the shape of the inner surface 9. In other words, the contact surface 36 reproduces in negative, that is to say in an inverted manner, the raised sectors 12.

In such an implementation, the securing step 104 is carried out as follows. The sheet 7 is placed on the die 33, the detection surfaces 21 provided with cutouts 31 being positioned facing the movable parts 35. The movable parts 35 are in the retracted position. Such a situation is shown in FIG. 9.

In a first movement, the die 33 is approached to the inner surface 9 so as to reach a proximal position, allowing the fixed parts 34 to be applied against the sheet 7. In this way the inoperative zones 10 can be glued. In such a first movement, the movable parts 35 preferably remain retracted, and do not interfere with the sheet 7. Such a situation is shown in FIG. 10.

In a second movement, the die 33 is held in the proximal position, the movable parts 35 are translated towards the sheet 7 so that they can be placed in the contact position. In such a position, the movable parts 35 are able to press the detection surfaces 21 against the raised sectors 12 of the panel 6. Such a situation is shown in FIG. 11.

Advantageously, the first movement precedes the second movement, which allows the assembly by gluing of the inoperative zones 10, before the gluing of the flaps 24 against the edge 15. In addition, this promotes the formation of folding 23, hinges 26, folds 27 and thus considerably reduces the risk of offset between the facets 25 and the edges 15. The occurrence of the phenomenon of deformation of the sensors 20 is considerably limited, which avoids any recalibration after assembly of the panel 6.

In alternative implementations, the first movement and the second movement are carried out simultaneously, which saves time during the manufacture of the detection assembly 3.

In the shown embodiments, the movable parts 35 have a complementary shape with the raised sectors 12, which facilitates the installation of the facets 25 on the edges 15.

In non-shown implementations, the movable parts have a finger shape. Such movable parts 35 offer less precision, but make it possible to avoid a tool change in the event of modification of the shape of the raised sectors 12.

In other non-shown implementations, the die-forging machine 32 comprises both movable parts 35 having a finger shape, and other movable parts 35 having complementary shapes with the raised sectors 12.

In other non-shown implementations, and in the case of carrying out a securing step 104 using a die-forging machine 32, the movable part 35 is not limited to the production of a single movement, but performs a plurality of movements so as to apply each of the facets 25 to a respective edge 15.

The detection assembly 3 thus manufactured, an intermediate element 4, then an electronic card are advantageously assembled to the detection assembly 3, by means known to those skilled in the art, during an assembly step 105, shown in FIG. 12. Such an assembly step 105 allows the formation of the control device 1.

The method for manufacturing the control device 1 offers numerous advantages such as for example:
the production of a control device 1 having sensors 20 not requiring recalibration after shaping the control device 1,
the possibility of positioning flaps 24 in raised sectors 12 having complex shapes,
reduced energy use compared to a method using thermoforming,
possible implementation on pre-existing machines such as a die-forging machine,
reduced manufacturing time.

1. A method for manufacturing a detection assembly for a control device intended to be integrated into a passenger compartment of a motor vehicle, the detection assembly including
a panel comprising at least one raised sector provided with an edge
a sheet comprising at least one detection surface provided with at least one sensor, the method comprising:
a step of forming at least one flap in the at least one detection surface,
a positioning step in which the sheet is positioned facing the panel, the at least one detection surface being positioned facing the at least one raised sector,
a securing step in which the sheet is applied against the panel, the at least one flap being displaced during the securing step to come into contact with at least one edge of the at least one raised sector.

2. The method according to claim 1, wherein the method further comprises a forming step comprising a production of cutouts within the at least one detection surface, according to a predetermined pattern, so as to define the at least one flap.

3. The method according to claim 2, wherein the cutouts are made using a cookie cutter tool or a laser.

4. The method according to claim 1, wherein the method further comprises between the forming step and the positioning step, or before the forming step, a gluing step comprising application of a glue to the sheet.

5. The method according to claim 4, wherein the sheet is provided with an inactive surface devoid of the at least one sensor, the gluing step comprises application of a first glue on the inactive surface, and a second glue on the at least one detection surface, so that after hardening of the first glue and the second glue, the second glue provides rigidity greater than that of the first glue.

6. The method according to claim 1, wherein the securing step is carried out by a die-forging machine, the die-forging machine comprising a die provided with at least one movable part and at least one fixed part, the at least one movable part being able to translate relative to the at least one fixed part so as to move between a retracted position and a contact position, the sheet being arranged on the die such that the at least one movable part is facing the at least one detection surface, the die-forging machine performing a first movement aimed at positioning the sheet against the panel via the at least one fixed part, and during a second movement, the at least one movable part is translated from a retracted position to a contact position so as to apply the at least one detection surface against the at least one raised sector.

7. A detection assembly including:
a panel comprising at least one raised sector provided with at least one edge
a sheet comprising at least one detection surface provided with at least one sensor, the sheet being secured facing the panel, the at least one detection surface being positioned facing the at least one raised sector, wherein the detection assembly comprises at least one flap secured to an edge of the at least one raised sector.

8. The detection assembly according to claim 7, wherein the at least one flap comprises a plurality of sensors each of the plurality of sensors being positioned on a respective facet of a plurality of facets, one of the plurality of facets being secured to one respective edge of the at least one raised sector, the plurality of facets being separated from each other by means of folds, and the plurality of facets comprising a first side forming hinge allowing the at least one flap to be connected to the sheet.

9. A control device comprising the detection assembly according to claim 8.

10. A vehicle comprising the control device according to claim 9.

11. The method according to claim 2, wherein the method further comprises between the forming step and the positioning step, or before the forming step, a gluing step comprising application of a glue to the sheet.

12. The method according to claim 3, wherein the method further comprises between the forming step and the positioning step, or before the forming step, a gluing step comprising application of a glue to the sheet.

13. The method according to claim 11, wherein the sheet is provided with an inactive surface devoid of the at least one sensor, the gluing step comprises application of a first glue on the inactive surface, and a second glue on the at least one detection surface, so that after hardening of the first glue and the second glue, the second glue provides rigidity greater than that of the first glue.

14. The method according to claim 12, wherein the sheet is provided with an inactive surface devoid of the at least one sensor, the gluing step comprises application of a first glue on the inactive surface, and a second glue on the at least one detection surface, so that after hardening of the first glue and the second glue, the second glue provides rigidity greater than that of the first glue.

15. The method according to claim 2, wherein the securing step is carried out by a die-forging machine, the die-forging machine comprising a die provided with at least one movable part and at least one fixed part, the at least one movable part being able to translate relative to the at least one fixed part so as to move between a retracted position and a contact position, the sheet being arranged on the die such that the at least one movable part is facing the at least one detection surface, the die-forging machine performing a first movement aimed at positioning the sheet against the panel via the at least one fixed part, and during a second movement, the at least one movable part is translated from a retracted position to a contact position so as to apply the at least one detection surface against the at least one raised sector.

16. The method according to claim 3, wherein the securing step is carried out by a die-forging machine, the die-forging machine comprising a die provided with at least one movable part and at least one fixed part, the at least one movable part being able to translate relative to the at least one fixed part so as to move between a retracted position and a contact position, the sheet being arranged on the die such that the at least one movable part is facing the at least one detection surface, the die-forging machine performing a first movement aimed at positioning the sheet against the panel via the at least one fixed part, and during a second movement, the at least one movable part is translated from a retracted position to a contact position so as to apply the at least one detection surface against the at least one raised sector.

17. The method according to claim 4, wherein the securing step is carried out by a die-forging machine, the die-forging machine comprising a die provided with at least one movable part and at least one fixed part, the at least one movable part being able to translate relative to the at least one fixed part so as to move between a retracted position and a contact position, the sheet being arranged on the die such that the at least one movable part is facing the at least one detection surface, the die-forging machine performing a first movement aimed at positioning the sheet against the panel via the at least one fixed part, and during a second movement, the at least one movable part is translated from a retracted position to a contact position so as to apply the at least one detection surface against the at least one raised sector.

18. The method according to claim 5, wherein the securing step is carried out by a die-forging machine, the die-forging machine comprising a die provided with at least one movable part and at least one fixed part, the at least one movable part being able to translate relative to the at least one fixed part so as to move between a retracted position and a contact position, the sheet being arranged on the die such that the at least one movable part is facing the at least one detection surface, the die-forging machine performing a first movement aimed at positioning the sheet against the panel via the at least one fixed part, and during a second movement, the at least one movable part is translated from a retracted position to a contact position so as to apply the at least one detection surface against the at least one raised sector.

19. The method according to claim 13, wherein the securing step is carried out by a die-forging machine, the die-forging machine comprising a die provided with at least one movable part and at least one fixed part, the at least one movable part being able to translate relative to the at least one fixed part so as to move between a retracted position and a contact position, the sheet being arranged on the die such that the at least one movable part is facing the at least one detection surface, the die-forging machine performing a first movement aimed at positioning the sheet against the panel via the at least one fixed part, and during a second movement, the at least one movable part is translated from a retracted position to a contact position so as to apply the at least one detection surface against the at least one raised sector.

20. The method according to claim 14, wherein the securing step is carried out by a die-forging machine, the die-forging machine comprising a die provided with at least one movable part and at least one fixed part, the at least one movable part being able to translate relative to the at least one fixed part so as to move between a retracted position and a contact position, the sheet being arranged on the die such that the at least one movable part is facing the at least one detection surface, the die-forging machine performing a first movement aimed at positioning the sheet against the panel via the at least one fixed part, and during a second movement, the at least one movable part is translated from a retracted position to a contact position so as to apply the at least one detection surface against the at least one raised sector.
